(19) United States
(12) Patent Application Publication
(10) Pub. No.: US 2026/0138410 A1
(43) Pub. Date: May 21, 2026

(54) Control of a Motor Vehicle

(71) Applicant: Bayerische Motoren Werke Aktiengesellschaft, Muenchen (DE)

(72) Inventor: Stefaan DUYM, Muenchen (DE)

(21) Appl. No.: 19/377,498

(22) Filed: Nov. 3, 2025

(30) Foreign Application Priority Data
Nov. 19, 2024 (DE) 10 2024 133 944.6

(51) Int. Cl. B60G 17/0165

(52) U.S. Cl. CPC B60G 17/0165; B60G 2400/80; B60G 2400/95

(57) ABSTRACT

A motor vehicle includes an active chassis and a body, wherein the chassis can be actuated to control a distance between the body and the ground, and a method for controlling such a motor vehicle includes determining a driver-controlled actuation of the chassis in order to deflect a chassis clearance at the body of the motor vehicle from a neutral position, determining a geographical candidate position of the motor vehicle, determining a predetermined number of additional candidate positions at which corresponding driver-controlled actuations of the chassis have been carried out, wherein the candidate positions are located in an area of a predetermined size, and determining a hazard zone, wherein the hazard zone includes the candidate positions.

### CROSS REFERENCE TO RELATED APPLICATION

This application claims priority under 35 U.S.C. § 119 from German Patent Application No. DE 10 2024 133 944.6, filed Nov. 19, 2024, the entire disclosure of which is herein expressly incorporated by reference.

### BACKGROUND AND SUMMARY

The present disclosure relates to the control of a motor vehicle. In particular, the present disclosure relates to the control of an active chassis of the motor vehicle.

A motor vehicle comprises an active chassis which can be actuated to change a vertical distance between a body and the ground. For example, the motor vehicle can be lowered relative to the ground in order to reduce the height of a loading sill, to lower the center of gravity, or to increase the aerodynamic efficiency. Under certain circumstances, the chassis can be automatically actuated to set the body to a favorable height relative to the ground.

If the body is low in relation to the ground, there is a risk that the body will come into contact with the ground, especially if the motor vehicle drives over a bump, a threshold or the beginning or end of a ramp. A driver can manually actuate the chassis on an uneven ground to set a predetermined height and thus avoid contact with the ground. However, the driver has other tasks and in some circumstances requires a certain amount of time to operate the active chassis, and so contact with the ground cannot be ruled out. Contact can result in damage to the body and adversely affect the ability of the motor vehicle to drive.

An object on which the present disclosure is based relates to the provision of an improved technique for controlling an active chassis of a motor vehicle in order to prevent contact between the ground and a body of the motor vehicle. This object is achieved according to the subject matter of the present disclosure, which also provides preferred embodiments.

A motor vehicle comprises an active chassis and a body, wherein the chassis can be actuated to control a vertical distance between the body and the ground. According to a first aspect of the present disclosure, a method for controlling such a motor vehicle comprises steps of determining a driver-controlled actuation of the chassis in order to deflect a chassis clearance at the body of the motor vehicle from a neutral position; determining a geographical candidate position of the motor vehicle; determining a predetermined number of additional candidate positions at which corresponding driver-controlled actuations of the chassis have been carried out, wherein the candidate positions are located in an area of a predetermined size; and determining a hazard zone, wherein the hazard zone includes the candidate positions.

If the motor vehicle is repeatedly driven over a point where, for example, there is a risk of contact between the ground and the body due to a bump or a ramp, a hazard zone may be defined at this point. If the motor vehicle enters the hazard zone at a later stage, an indication of the risk of bottoming out may be provided to a person inside the motor vehicle.

To determine a hazard zone, it may be sufficient to repeatedly determine the driver-controlled raising of the body above the ground. The number of times the determination must take place before a hazard zone is created may be predetermined. The size of the area in which the candidate positions of a hazard zone are located may be selected in such a way that candidate positions corresponding to the same hazard are combined into a single hazard zone. It is possible to take into account the fact that the driver can actuate the chassis ahead of time, so that the geographical position of the motor vehicle at the time of the actuation does not correspond exactly to the geographical position of the hazardous location. The size of the area can also improve a resistance of the determination to measurement errors, inaccurate human control, or a non-punctiform hazardous location. The hazard zone can only be better determined where there is a real risk of contact between the ground and the body.

The neutral position is usually specified by a manufacturer of the motor vehicle and generally includes a vertical position of the body above the ground, which is appropriate for most driving conditions or a normal driving condition. In some vehicles, the body can only be raised from the neutral position, only lowered in others, and optionally raised or lowered in others. In other words, the chassis can only be controlled in one or both directions from the neutral position. If no neutral position is defined, the lowest position can be assumed as the neutral position for detecting driver-controlled raising or the highest position can be assumed as the neutral position for detecting driver-controlled lowering.

For example, raising can be controlled to counteract the risk of the body coming into contact with the ground in the area around a bump, ramp or other unevenness.

Lowering can be controlled, for example, to lower a center of gravity of the motor vehicle, for example at high speed or in sport mode, to drive better under a low obstacle such as a gate or an entrance, or to lower a loading sill together with the body, so that a large or heavy object can be more easily brought on or off board.

The method can be applied to both hazard zones of a first type in which the body is raised and to those of a second type in which the body is lowered. It is also possible to take into account hazard zones of both types. Hazard zones of different types should not overlap as far as possible. An overlap of such hazard zones can be resolved automatically, for example by deforming both hazard zones so that they no longer overlap, but are next to or adjacent to one another.

In another embodiment, in the event of an overlap, a hazard zone of one type may have priority over a hazard zone of the other type. In particular, a hazard zone in which the body is raised to prevent it from bottoming out may have priority over a hazard zone in which the body is lowered. This control be limited to cases in which the speed of the motor vehicle exceeds a predetermined value. For example, if the motor vehicle is stationary, a hazard zone for lowering may have priority over a hazard zone for raising. Even if the speed of the motor vehicle exceeds another predetermined value, lowering may have priority over raising.

It is also preferred that a confirmation of a candidate position is detected by a person on board the motor vehicle. This person may include, in particular, a driver of the motor vehicle. If driver-controlled control of the chassis has been determined, the candidate position can be determined and the person can be asked to confirm the candidate position. If there is no confirmation for a predetermined period of time, the candidate position can be discarded. Optionally, the person can also manually discard a determined candidate position.

The hazard zone may be selected to be equal to or larger than the area. In one preferred embodiment, the area and/or the hazard zone are circular. The hazard zone may include a reference point or center point to which a geographical position is assigned and a radius describing its size. If multiple hazard zones are determined, they may have the same sizes or the same radii.

A geographical location of the hazard zone can be determined as the average of the candidate positions. In one variant, a sufficient number of candidate positions can first be collected to determine a hazard zone, and the hazard zone can only then be determined in relation to the candidate positions. In another variant, an existing candidate position can be combined with a newly defined candidate position. An existing candidate position can have a weighting determined on the basis of a number of candidate positions already considered. When adding a new candidate position, the weighting can be taken into account to determine the position of the center of the hazard zone relative to the newly determined candidate position. In this variant, less memory space may be required or an existing memory location may be used to determine a larger number of candidate positions or hazard zones.

In one embodiment, candidate positions are stored cyclically in a predetermined number of memory locations. The memory locations can form a ring memory whose elements can be described in a predetermined order by candidate positions. If the ring memory is full, a newly determined candidate position can overwrite the oldest previously determined candidate position in the ring memory. The same technique for cyclic storage in a predetermined number of memory locations can also be used for certain hazard zones. A dedicated ring memory is preferably provided for this purpose.

The chassis can be controlled automatically to ensure a predetermined distance between the body and the ground if a geographical position of the motor vehicle is located within a hazard zone. The hazard zone may be determined in the manner described above. The height of the body relative to the ground can be averaged from the driver-controlled heights at candidate positions that are included in the hazard zone. If such information is not available, the chassis can be actuated in the area of the hazard zone to be adjusted to a predetermined position. This position may correspond to a maximum ground clearance.

The chassis can only be actuated temporarily to the predetermined distance. For example, the actuation can be undone when the motor vehicle leaves a hazard zone. In this case, a height that was in place before entering the hazard zone can be set on the chassis. Alternatively, a predetermined height can be set.

It should be noted that the height of the body above the ground may have been set automatically or in a manner controlled by the driver before entering the hazard zone. In one embodiment, driver-controlled lowering of the body below a predetermined height will be prevented while the motor vehicle is within the hazard zone. This height can correspond in particular to the automatically actuated height.

In another embodiment, a determined hazard zone is provided to another motor vehicle. For this purpose, the hazard zone can be transmitted to an entity outside of the motor vehicle. The external entity can collect and, if necessary, combine hazard zones for a large number of motor vehicles. In yet another embodiment, hazard zones can also be exchanged between motor vehicles more directly and, for example, can be transmitted by vehicle-to-vehicle (car-to-car, C2C) or vehicle-to-infrastructure (car-to-infrastructure, C2I). Determined candidate positions can also be handled in a similar manner.

Conversely, an externally determined hazard zone can also be received and processed on board the motor vehicle in question. For example, the hazard zone can be received directly from an entity outside of the motor vehicle or from the additional motor vehicle. In a corresponding manner, a candidate position can also be received from the additional motor vehicle and evaluated according to a local candidate position.

In yet another embodiment, a candidate position can be determined on the basis of a POI (point of interest) representing a ground unevenness. To this end, an external entity can receive a street map, or more precisely, a level of a street map. Potholes or similar ground unevennesses may be noted in predetermined data structures.

Optionally, a candidate position is discarded if it is within a predetermined distance from a hazard zone that has already been determined or received. A gradual change in a hazard zone can thus be counteracted. Candidate positions that do not originally belong to the same hazard zone can be better kept separate from one another.

Another aspect of the present disclosure proposes a device for controlling a motor vehicle having an active chassis and a body. The chassis can be actuated to control a distance between the body and the ground. For example, the active chassis may comprise an air suspension in which the distance between the body and the ground can be controlled by increasing or decreasing the quantity of air in an air spring bellows mounted between a wheel and the body.

The device comprises a first interface for determining a driver-controlled actuation of the chassis in order to increase a ground clearance at the body of the motor vehicle; a positioning apparatus for determining a geographical candidate position of the motor vehicle; and a processing apparatus. The processing apparatus is configured to determine a predetermined number of additional candidate positions at which corresponding driver-controlled actuations of the chassis have been carried out, wherein the candidate positions are located in an area of a predetermined size. Furthermore, the processing apparatus is configured to determine a hazard zone in which there is a risk of contact between the ground and the body of the motor vehicle; wherein the hazard zone includes the candidate positions.

The processing apparatus is preferably configured to partly or fully carry out a method described herein. For this purpose, the processing apparatus may be of electronic design and include, for example, an integrated circuit, a programmable logic chip or a programmable microcomputer. The method may be implemented in the form of a configuration or as a computer program product having program code for the processing apparatus. The configuration or the computer program product may be stored on a computer-readable data carrier. Features or advantages of the method may be transferred to the device or vice versa.

The device preferably furthermore comprises a memory device in which candidate positions and/or hazard zones can be stored. Both can be determined by the device or can be received externally. To transmit such information, the device may include a communication apparatus which is preferably of wireless design. For example, candidate positions can be received from an additional motor vehicle or from an external entity that can collect candidate positions from multiple motor vehicles and, if necessary, process them together.

The device may have a second interface for controlling the chassis, wherein the processing apparatus is configured to automatically actuate the chassis to ensure a predetermined distance between the body and the ground if a geographical position of the motor vehicle is within a hazard zone.

If the distance between the body and the ground when entering the hazard zone is already at least as great as the predetermined distance, further control of the chassis can be dispensed with. Otherwise, if the current distance is smaller than the predetermined distance, the chassis can be actuated to raise the body with respect to the ground accordingly.

According to yet another aspect of the present disclosure, a motor vehicle comprises an apparatus described herein. The motor vehicle may include, in particular, an automobile, a truck or a bus. The motor vehicle preferably comprises at least two axles, and the chassis can act on both axles. This can prevent the body from coming into contact with the ground at a front or rear end or between the axles.

The present disclosure will now be described in more detail with reference to the accompanying drawings, in which:

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 illustrates a system;

FIG. 2 illustrates a flowchart of a first method;

FIG. 3 illustrates a flowchart of a second method;

FIGS. 4a, 4b, 4c, and 4d illustrate a first variant of the determination of a hazard zone; and

FIG. 5 illustrates a second variant of the determination of a hazard zone

### DETAILED DESCRIPTION OF THE DRAWINGS

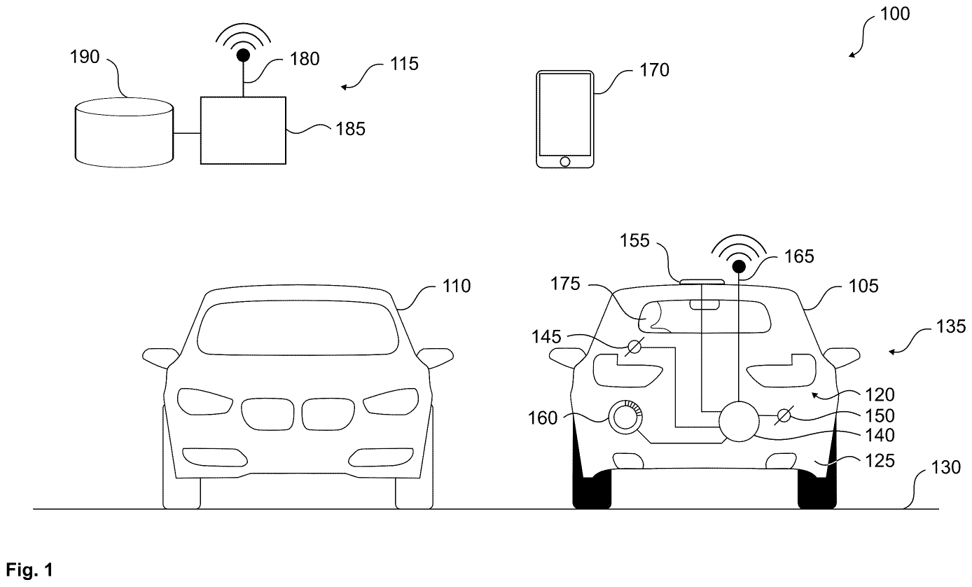

FIG. 1 shows a system 100 comprising a motor vehicle 105, possibly one or more additional motor vehicles 110, and also optionally an external entity 115.

The motor vehicle 105 comprises an active chassis 120 which can be actuated to change a vertical distance between a body 125 of the motor vehicle 105 and the ground 130. In the context of this disclosure, the height of the body 125 above the ground 130 is considered to be a nominal value which is set under predetermined conditions and may deviate from an instantaneous value in practice, for example under the influence of cornering, vibrations or accelerations.

The active chassis 120 may include, for example, air suspension or electrical adjustment of a conventional suspension with leaf, torsion bar or coil springs. Optionally, additional aspects such as damping of the chassis 120 can be controlled. The chassis 120 can be brought manually or in a predetermined driving state of the motor vehicle 105 automatically to a predetermined position, so that a corresponding distance results between the body 125 and the ground 130.

A device 135 comprising a processing apparatus 140, a first interface 145, a second interface 150 and a positioning apparatus 155 is located on board the motor vehicle 105. A memory device 160 is also preferably provided. Furthermore, a communication apparatus 165 for, in particular wireless, communication with the additional motor vehicle 110 or the external entity 115 is optionally provided. Furthermore, it is optionally possible to communicate with a mobile device 170.

The device 135 may be configured, on the one hand, to define geographical parameters of a hazard zone in which there is a risk of contact between the ground 130 and the body 125. On the other hand, the device 135 can be used to control the active chassis 120 in a hazard zone in such a way that this hazard is reduced.

The first interface 145 may be used by a person 175, in particular a driver, on board the motor vehicle 105 to control the active chassis 120. In particular, raising or lowering of the active chassis 120 can be controlled via the first interface 145. In this case, a relative or absolute height of the body 125 above the ground 130 can be predetermined. The second interface 150 can be directly connected to the active chassis 120 or an actuator. Alternatively, a dedicated control unit is provided for controlling an actuator of the chassis 120, and the second interface 150 may be connected to this control unit.

The positioning apparatus 155 is configured to determine a geographical position of the motor vehicle 105. Continuous position determination is preferably carried out, for example on the basis of signals from a global satellite-based navigation system GNSS. Alternatively, the position can also be determined, for example, on the basis of accelerations, an orientation of the motor vehicle 105 in the magnetic field of the earth and/or by a SLAM method on the basis of registered landmarks and respective geographical positions assigned to the landmarks. Other types of position are also possible.

The memory device 160 is configured to store candidate positions and/or hazard zones, which are described in more detail herein. One or more additional parameters, which can also be stored in the memory device 160, can be assigned to candidate position or a hazard zone. The memory device 160 may comprise a ring memory, which comprises a predetermined number of memory locations each able to store a candidate position or a hazard zone and optionally assigned parameters. The memory locations are organized in a ring and are described in a predetermined order by new objects. If all memory locations are occupied, the oldest memory location already occupied is automatically overwritten.

Information stored in the memory device 160 can optionally be viewed and/or edited by a person 175. An item of information can be created, deleted, moved or changed. In one embodiment, the information can be viewed via the first interface 145. The first interface 145 may include, for example, a touch-sensitive screen on board the motor vehicle 105. Alternatively, a stored item of information can be accessed by the mobile device 170 using a corresponding application. The mobile device 170 can exchange information with the device 135 via its communication apparatus 165. For example, mobile data radio, WLAN or Bluetooth technology can be used.

The device 135 can also provide or receive information externally via the communication apparatus 165. In particular, candidate positions or hazard zones can be exchanged with an additional motor vehicle 110 or the external entity 115.

The external entity 115 preferably comprises an interface 180 for communication with a motor vehicle 105, 110; in addition, a processing apparatus 185 and preferably also a memory device 190. The external entity 115 can receive information from one or more motor vehicles 105, 110 with respect to candidate positions and/or hazard zones via the interface 180. This information can be stored in the memory device 190. Optionally, the items of information can be compared with one another, for example to eliminate outliers, reduce measurement errors or increase confidence. Correspondingly combined or adjusted information may be transmitted to one or more motor vehicles 105, 110.

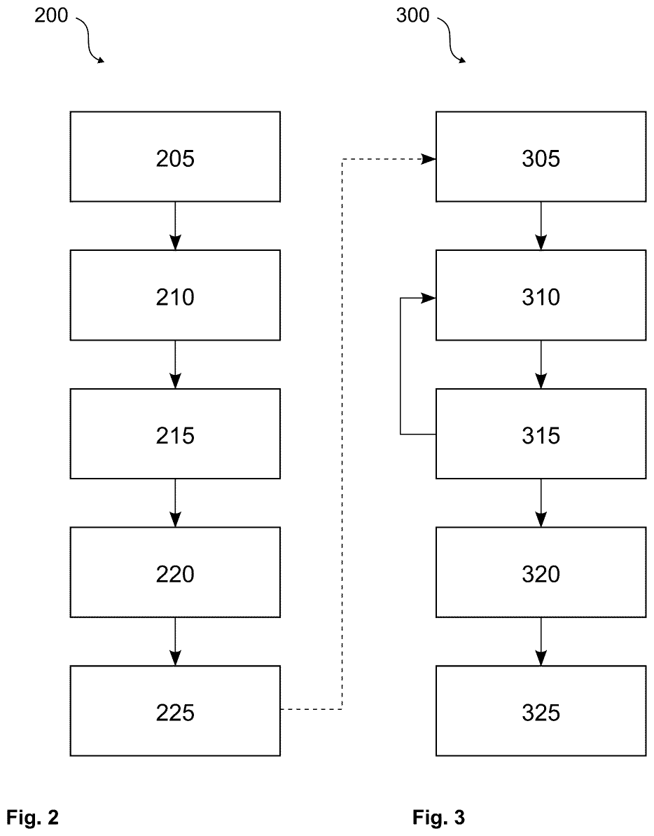

FIG. 2 shows a flowchart of a first method 200 for determining a hazard zone for a motor vehicle 105. In a step 205, control of the active chassis 120 by the person 175 on board the motor vehicle 105 can be detected. For example, it is assumed that the control process raises the body 125 above the ground 130.

In a step 210, a geographical position of the motor vehicle 105 can be determined at the time of the control in step 205. There is the possibility that the person 175 wants to raise the chassis 120 in order to counteract possible contact between the ground 130 and the body 125 at a ground unevenness. The person 175 may be asked to confirm that they are approaching a corresponding hazard zone. The person 175 may give this confirmation, disagree or not react at all. If no confirmatory input from the person 175 is determined during a predetermined time or a predetermined journey, the determined geographical position may be discarded.

If the person 175 confirms the possible hazard zone, the determined position can be stored as a candidate position. A candidate position may designate a geographical position located in the area of a ground unevenness, which facilitates ground contact with the body 125. A candidate position is initially supported only by a single observation in the sense of steps 205, 210. Candidate positions can be stored in the memory device 160 of the device 135 on board the motor vehicle 105.

In a step 215, it is possible to determine how many additional candidate positions are located within the area of the newly defined candidate position. Only candidate positions that are within an area of a predetermined size are taken into account. The area is preferably circular. In other words, all candidate positions with pairs of relative distances below a predetermined threshold can be determined. It is not possible to check whether the number of determined candidate positions exceeds a predetermined threshold value. If this is not the case, the candidate positions or equivalent item of information remain in the memory device 160, and the first method 200 terminates at this point.

Otherwise, if a sufficient number of candidate positions sufficiently close to one another have been identified in step 215, a hazard zone in which the candidate positions in question are located can be determined in a step 220. The hazard zone preferably has a center point or reference point to which a geographical position is assigned. In addition, the hazard zone has a predetermined shape, for example that of a circle. A surface area of the hazard zone is usually the same size or larger than the area set in step 215.

The hazard zone can be provided in a step 225. Candidate positions that have contributed to the hazard zone can be removed from the memory device 160. The hazard zone can be stored in the memory device 160. In addition, the hazard zone can be transmitted by the communication apparatus 165 to an additional motor vehicle 110 or the external entity 115.

FIG. 3 shows a flowchart of a second method 300 for controlling a motor vehicle 105. The second method 300 can be carried out in a manner integrated with the first method 200.

A hazard zone is determined in a step 305. The hazard zone is usually stored in the memory device 160 and may either have been created there by the first method 200 or may have been received externally. For example, an event-controlled or time-controlled hazard zone can be received from an additional motor vehicle 110 or the external entity 115. A received hazard zone can be matched with an already known hazard zone.

In a step 310, the geographical position of the motor vehicle 105 is determined. In a step 315, it is possible to check whether the determined geographical position is within a hazard zone. These steps can be carried out continuously or cyclically, so that it is possible to notice in a timely manner when the motor vehicle 105 enters a hazard zone.

If the motor vehicle 105 is in a hazard zone, the active chassis 120 can be actuated in a step 320 to raise the body 125. The hazard zone can be assigned a height that the body 125 should have above the ground 130. If a current height is greater than or equal to this value, a control process can be omitted. Otherwise, the body 125 can be raised accordingly by the chassis 120. If no height is assigned to the hazard zone, the body 125 can be controlled to a predetermined height or the maximum height.

In a step 325, it is possible to determine whether the motor vehicle 105 is located outside hazard zones. Alternatively, it is possible to determine whether a predetermined time has elapsed since entering the hazard zone or whether the motor vehicle 105 has traveled a predetermined distance. In this case, the chassis 120 can be actuated to lower the body 125 again. The body 125 is preferably lowered to a height above the ground 130 that it had before entering the hazard zone. Optionally, the height control of the body 125 can be transferred to an automatic unit that can control the height based on a current driving state of the motor vehicle 105.

The methods 200 and 300 can be carried out in an appropriate manner with respect to driver-controlled lowering. Hazard zones of a first type in which the body 125 is raised and hazard zones of a second type in which the body 125 is lowered can also be distinguished. In this case, it is preferable that one type of a determined hazard zone or an associated candidate position is stored and taken into account accordingly.

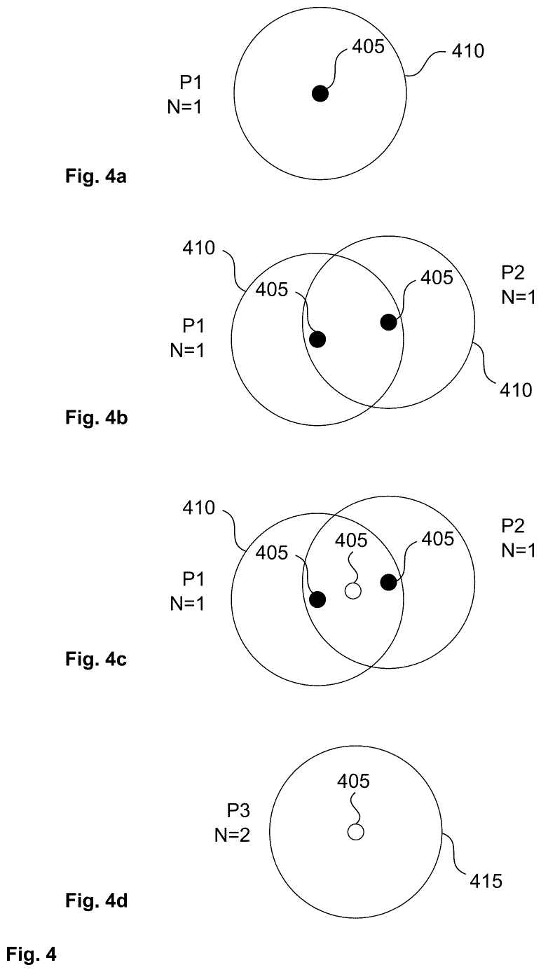

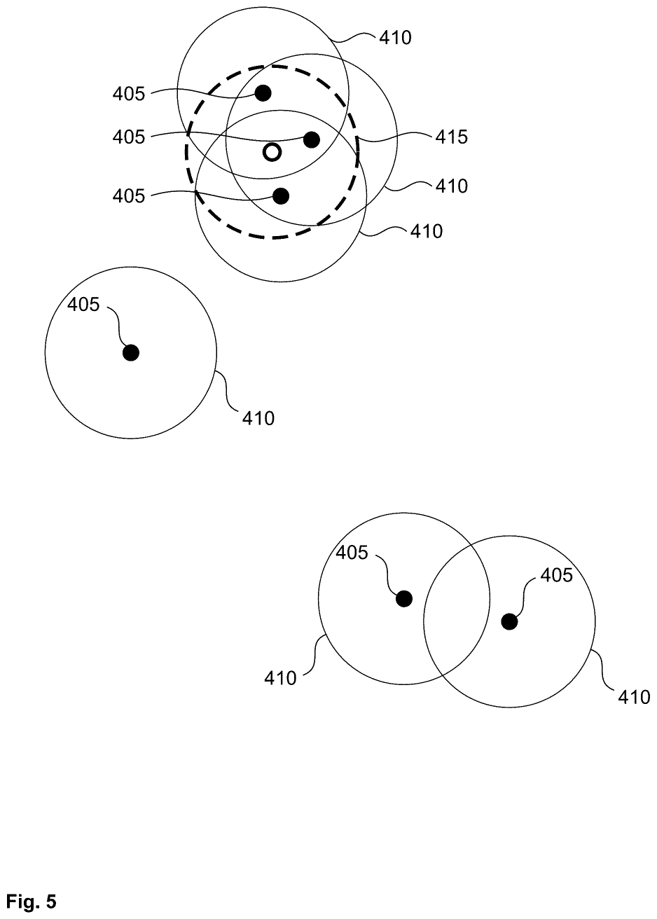

FIG. 4 shows an illustration of a first variant of the determination of a hazard zone. Subfigures 4a to 4d build logically on one another.

An exemplary candidate position 405 is illustrated with reference to FIG. 4a. The candidate position 405 is assigned the example reference P1 and a cardinality N=1, indicating that the candidate position 405 is based on a single observation. A circular area 410 is shown around the candidate position 405 for estimating the scales. Multiple candidate positions 405 can be identified as sufficiently close to one another if they are in a common area 410.

With reference to FIG. 4b, an additional candidate position 405 is also determined, to which the reference P2 is assigned, for example. The cardinality N is also 1. The candidate positions 405 lie mutually in the respective assigned areas 410 and can therefore be determined as close to one another.

Referring to FIG. 4c, the two candidate positions 405 can be merged into a joint candidate position 405, shown in a light color here. A geographical position of the newly formed candidate position 405 is located half way in the x-direction and in the y-direction or in the direction of a longitude and in the direction of a latitude between the corresponding components of the geographical positions of the two determined candidate positions 405 from FIG. 4b illustrated in dark color.

Referring to FIG. 4d, new attributes can be assigned to the newly determined candidate position 405, for example a new reference P3 and a cardinality determined from the sum of the cardinalities of the covered candidate positions 405, in the present example thus N=2. Candidate positions 405 that have been added to the newly designated candidate position 405 can be deleted.

If the cardinality has reached a predetermined threshold value, a hazard zone 415 can be determined on the basis of the candidate position 405. A geographical position of the hazard zone 415 may correspond to the geographical position of the candidate position 405. Purely by way of example, in FIG. 4, the hazard zone 415 has the same shape and size as an area 410, but in other embodiments, a different size and/or a different shape may also be chosen.

The procedure shown allows a required memory space in the memory device 160 to be minimized. Candidate positions 405 that are part of the same hazard zone 415 can be better linked to one another.

FIG. 5 shows a second variant of the determination of a hazard zone 415. As in FIG. 4, multiple candidate positions 405 with respectively assigned areas 410 are illustrated. Each determined candidate position 405 is stored individually in the memory device 160 as illustrated. In the variant shown, cardinalities are not taken into consideration.

In an upper region of FIG. 5, three candidate positions 405 are close enough together to be able to be included in a common area 410. If this is the case for a sufficient number of candidate positions 405, a hazard zone 415 can be determined. A geographical location of the hazard zone 415 can be determined as the average of the geographical positions of the candidate positions 405. The geographical position of the hazard zone 415 is indicated in FIG. 5 as a light circle in the center of the hazard zone 415 illustrated with a dashed line. If a hazard zone 415 has been determined, candidate positions 405 that were used for their formation can be deleted.

In an area offset slightly downward and to the left in the illustration, an additional candidate position 405 lying outside the determined hazard zone 415 is visible. At the same time, the candidate position 405 is located at a distance from the hazard zone 415 that falls below a predetermined value. This candidate position 405 can be discarded to prevent the existing definition of the hazard zone 415 from being changed.

Candidate positions 405 illustrated in a lower region of FIG. 5 are far enough away from a hazard zone 415 to contribute to the formation of a hazard zone 415. In the present case, it is assumed that three candidate positions 405 are required to form a hazard zone, and so an additional further hazard zone 415 cannot be formed here yet.

Although storing individual candidate positions 405 without cardinality in this variant requires more memory space in the memory device 160, this facilitates the subsequent viewing or editing of candidate positions 405.

The foregoing disclosure has been set forth merely to illustrate the present disclosure and is not intended to be limiting. Since modifications of the disclosed embodiments incorporating the spirit and substance of the present disclosure may occur to persons skilled in the art, the invention should be construed to include everything within the scope of the appended claims and equivalents thereof.

### REFERENCE SIGNS

100 System
105 Motor vehicle
110 Additional motor vehicle
115 External entity
120 Active chassis
125 Body
130 Ground
135 Device
140 Processing apparatus
145 First interface
150 Second interface
155 Positioning apparatus
160 Memory device
165 Communication apparatus
170 Mobile device
175 Person, driver
180 Interface
185 Processing apparatus
190 Memory device
200 First method
205 Detect driver-controlled chassis control
210 Store geographic position as a candidate position?
215 At least N candidate positions with small mutual distances?
220 Determine hazard zone
225 Provide hazard zone
300 Second method
305 Determine hazard zone
310 Determine geographical position of the motor vehicle
315 Position in hazard zone?
320 Automatically control chassis to raise body
325 Automatically control chassis to lower body
405 Candidate position
410 Area
415 Hazard zone

What is claimed is:

1. A method for controlling a motor vehicle having an active chassis and a body, wherein the chassis is configured to be actuated to control a distance between the body and ground, the method comprising:
determining a driver-controlled actuation of the chassis in order to deflect a ground clearance at the body of the motor vehicle from a neutral position;
determining a geographical candidate position of the motor vehicle;
determining a predetermined number of additional candidate positions at which corresponding driver-controlled actuations of the chassis have been carried out, wherein the candidate positions are in an area of a predetermined size; and
determining a hazard zone, wherein the hazard zone includes the candidate positions.

2. The method according to claim 1, comprising:
detecting a confirmation of a candidate position by a person on board the motor vehicle.

3. The method according to claim 1, comprising:
determining a center point of the hazard zone as an average of the candidate positions.

4. The method according to claim 1, comprising:
determining and assigning a setting to the hazard zone on a basis of driver-controlled settings of the chassis at the candidate positions.

5. The method according to claim 1, comprising:
storing candidate positions cyclically in a predetermined number of memory locations.

6. The method according to claim 1, comprising:
actuating the chassis automatically to ensure a predetermined distance between the body and the ground in response to a geographical position of the motor vehicle being located within a hazard zone.

7. The method according to claim 6, comprising:
actuating the chassis only temporarily to the predetermined distance.

8. The method according to claim 1, comprising:
providing a determined hazard zone to an additional motor vehicle.

9. The method according to claim 1, comprising:
detecting a hazard zone determined by an additional motor vehicle.

10. The method according to claim 1, comprising:
determining a candidate position on a basis of a point of interest (POI) representing a ground unevenness.

11. The method according to claim 1, comprising:
rejecting a candidate position located within a predetermined distance from a hazard zone.

12. A device for controlling a motor vehicle having an active chassis and a body, wherein the chassis is configured to be actuated to control a distance between the body and ground, the device comprising:
a first interface configured to determine a driver-controlled actuation of the chassis in order to deflect a chassis clearance at the body of the motor vehicle from a neutral position;
a positioning device configured to determine a geographical candidate position of the motor vehicle; and
a processing device configured to:
determine a predetermined number of additional candidate positions at which corresponding driver-controlled actuations of the chassis have been carried out, wherein the candidate positions are in an area of a predetermined size; and
determine a hazard zone, wherein the hazard zone includes the candidate positions.

13. The device according to claim 12, further comprising:
a second interface configured to control the chassis,
wherein the processing device is configured to automatically actuate the chassis to ensure a predetermined distance between the body and the ground in response to a geographical position of the motor vehicle being located within a hazard zone.

14. A motor vehicle comprising:
the device according to claim 12.
